(19) United States
(12) Patent Application Publication
(10) Pub. No.: US 2009/0050072 A1
(43) Pub. Date: Feb. 26, 2009

(54) Door Mounted Cat Climbing Structure

(76) Inventors: Jeremy Moser, Valencia, CA (US); Angela Moser, Valencia, CA (US); Jonathan J. Helm, St. Cloud, MN (US)

Correspondence Address: David D. Stein;Boyle Fredrickson, S.C., 840 North Plankinton Avenue, Milwaukee, WI, 53203, US

(21) Appl. No.: 12/195,893

(22) Filed: Aug. 21, 2008

Related U.S. Application Data
(60) Provisional application No. 60/957,547, filed on Aug. 23, 2007.

(51) Int. Cl. A01K 15/02

(52) U.S. Cl. 119/706

(57) ABSTRACT

A door-mountable cat climbing structure that has a pair of mounting arrangements, at least one of which is biased by a biasing element in a manner that permits adjustment to fit the door while also facilitating secure mounting of the climbing structure thereon. In a preferred embodiment, a biasing element cooperates with a frame of the climbing structure to urge a mounting bracket into engagement with the door while permitting relative movement between the bracket and the door enabling adjustment as well as easy removal. The frame is a generally vertically extending spine from which one or more cat climbing platforms outwardly extend. In a preferred embodiment, the climbing structure includes staggered panels and a spine formed of pairs of adjacent panels coupled together via coupling assemblies that also clamp one of the platforms therebetween in a manner that also extends it outwardly.

CROSS-REFERENCE

This application claims the benefit under 35 U.S.C. § 119(e) of U.S. Provisional Application Ser. No. 60/957,547, filed Aug. 23, 2007, the entirety of which is expressly incorporated by reference herein.

### FIELD

The present invention relates to a cat exercise device and more particularly to a cat climbing structure that provides a plurality of cat perching areas and which is also capable of providing a scratching area for cats.

### BACKGROUND

Cats are naturally curious, possess a natural desire to climb and perch, and have a need to scratch. In response, products have been developed that are directed to one or more of these cat traits. Unfortunately, they typically either consume a great deal of space, are large and bulky and costly to ship, are difficult to assemble, or otherwise suffer from some other drawback.

In this regard, numerous cat trees have been developed, such as those disclosed in U.S. Pat. Nos. 3,479,991; 3,595,209; 3,604,397; 5,875,735 and 6,490,997, which are configured to allow a cat to climb on them to encourage exercise while taking advantage of a cat's instinct to be up high. While at least some of these cat trees have been commercially successful, improvements nonetheless remain desirable. For example, cat climbers take up a great deal of floor space, are often heavy and difficult to move, and can be quite challenging to assemble. Moreover, because their many parts are often large and bulky, shipping costs can be prohibitive driving up their overall cost to the consumer.

U.S. Pat. No. 5,275,128 discloses a door mounted cat scratching pad apparatus that is equipped with horizontal ledges that attaches to a door via upper and lower metal flanges. While more convenient than a cat tree, this apparatus also suffers from numerous drawbacks. For example, straps are used to keep the apparatus attached to the flanges. Such straps are prone to wear, tear and stretching over time. In addition, the straps overlie and support planar cat resting ledges interfering with the ability of a cat to easily climb up on them.

What is needed is a cat climbing device that is cost-effective to ship, easy to assemble, efficient in its use of space, and which can be implemented in a version that encourages scratching.

### SUMMARY

The present invention is directed to a pet exercise device that is a climbing structure that is mountable to a door, such as a standard residential door, and which is well suited for use by cats. The climbing structure includes at least one platform upon which a cat can climb that extends outwardly from a frame that serves as a spine or backbone that is mountable on a door. The climbing structure includes at least one mounting arrangement that facilitates door mounting.

In one preferred embodiment, the spine or backbone is composed of pairs of adjacent structurally supporting panels that are interconnected by coupling assemblies in a manner that enables a platform to extend outwardly therefrom. One preferred coupling assembly includes a fastener that engages adjacent panels drawing them together clamping them against a platform located between opposed panel ends or edges. One such fastener includes a head and/or washer disposed in one pocket of a coupling socket formed in one panel and a washer disposed in another pocket of a coupling socket formed in the adjacent panel that urges adjacent panels in tight clamping contact against a platform disposed therebetween when tightened. In one preferred embodiment, each fastener of each coupling assembly seats in a channel of the coupling socket of one panel that communicates with a like channel of a corresponding socket of an adjacent panel. To help secure the platform, a portion of each fastener extends through a bore in the platform that generally aligns with socket channels of adjacent panels. When assembled and tightened, the coupling assemblies urge the adjacent panels together into tight clamping contact with the platform forming a joint. When all of the panels are assembled in this manner, the result is an elongate platform-carrying spine that behaves as if it were of one-piece, substantially rigid and unitary construction.

The mounting arrangement is constructed and arranged to allow movement relative to the spine or backbone and the door to adjust the mounting arrangement for mounting the cat climbing structure to doors of different lengths or heights. In a preferred embodiment, the mounting arrangement includes an upper mounting bracket arrangement and a lower mounting bracket arrangement with at least one of the mounting brackets being resiliently biased in a manner that permits such mounting adjustment. In one preferred cat climbing structure, each mounting bracket arrangement includes a hook that extends from the spine or backbone and that has a lip defining a door-edge receiving channel for mounting over a top edge of a door or under a bottom edge of a door. The top hook is fixed to part of the spine or backbone and the bottom hook is resiliently biased by a biasing element that is in operable cooperation with the spine or backbone and the hook. In one preferred embodiment, the biasing element is a coil spring captured in compression in a channel formed in the spine or backbone against which a stop connected to a fastener of the bottom hook that rides in the channel bears. The bottom hook includes a mounting bracket section that slidably attaches the bottom hook to part of the spine and locates the stop so it is disposed in engagement with the biasing element. As a result, the bottom hook can be downwardly extended to accommodate doors of different lengths or heights.

In a method of assembly, adjacent pair of spine panels is arranged with their coupler sockets adjacent or in line with one another and with a corresponding platform generally perpendicularly disposed therebetween. Portions of a coupler assembly are placed in corresponding portions of each coupler socket of each panel interconnecting the panels. When tightened, each coupler assembly urges the panels together clamping one of the platforms therebetween. Where the coupler assembly includes a fastener, a portion of each fastener extends through a bore in the platform helping to keep the platform between the adjacent clamped panels. Such a modular assembly advantageously enables the climbing structure to be economically packaged, shipped, stored and assembled.

In a method of mounting the climbing structure on a door, an upper hook of an upper mounting arrangement is placed over the top edge of the door hooking it on the door. The bottom hook is pulled downwardly until its lip can pass through the gap between the bottom edge of the door and the floor, clearing the bottom edge of the door. The climbing structure is then maneuvered until the lip passes through the gap and the bottom edge of the door is received in the door receiving channel of the hook.

Releasing the bottom hook causes the biasing element to pull the bottom hook towards the top hook, positively clamping the door between the hooks advantageously positively mounting the climbing structure on the door. When the hooks are clamped on the door, the footprint of the cat climbing structure is advantageously minimized. In addition, the hooks are sufficiently thin that the door can be opened and closed without either hook contacting any part of the floor, door frame, or door jamb.

As a result of this resiliently biased hook construction, removal of the cat climbing unit from the door is as easy as its installation. In removal, the bottom hook is pulled downwardly toward the floor until its lip clears the bottom edge. Thereafter, application of manual force pulling the lip free of the door permits the climbing structure to advantageously be easily removed such that the climbing structure is easily mounted on a door and easily removed from the door. Such mounting and removal also advantageously requires no tools.

The spine is covered with an outer covering that can be a cat scratching material well suited for scratching by cats using their claws. Such material also extends to at least a portion of the back surface of the spine to prevent the door from being scratched or otherwise damaged while the climbing structure is mounted thereto. Each platform can also be covered with the same or a similar material. In a preferred embodiment, each platform is covered with carpeting and the spine is covered with a cat scratching material such as sisal or the like.

Other advantages, benefits and features of the present invention will become apparent to those skilled in the art upon reading the detailed description and viewing the related drawings.

### DRAWING DESCRIPTION

One or more preferred exemplary embodiments of the invention are illustrated in the accompanying drawings in which like reference numerals represent like parts throughout and in which:

FIG. 1 is a perspective view of a preferred embodiment of a cat climbing structure constructed in accordance with the present invention mounted on a door;

FIG. 2 is a rear elevation view the cat climbing structure mounted on the door, which is shown in phantom in FIG. 2;

FIG. 3 is an exploded view of the cat climbing structure;

FIG. 4 is a front elevation view of a top hook of the cat climbing structure;

FIG. 5 is a side elevation view of the top hook of FIG. 4;

FIG. 6 is a front elevation view of a bottom hook of the cat climbing structure;

FIG. 7 is a side elevation view of the bottom hook of FIG. 6;

FIG. 8 is a front elevation view of a lower spine panel;

FIG. 9 is a front elevation view of an intermediate spine panel;

FIG. 10 is a lower elevation view of an upper spine panel;

FIG. 11 is an enlarged fragmentary view of a preferred assembly joint arrangement;

FIG. 12 is a fragmentary perspective rear view of an upper portion of an assembled cat climbing unit;

FIG. 13 illustrates a fragmentary rear of a lower portion of the assembled cat climbing unit with a portion of the outer spine covering cutaway; and

FIG. 14 illustrates an exploded perspective view of the lower spine panel and lower hook.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

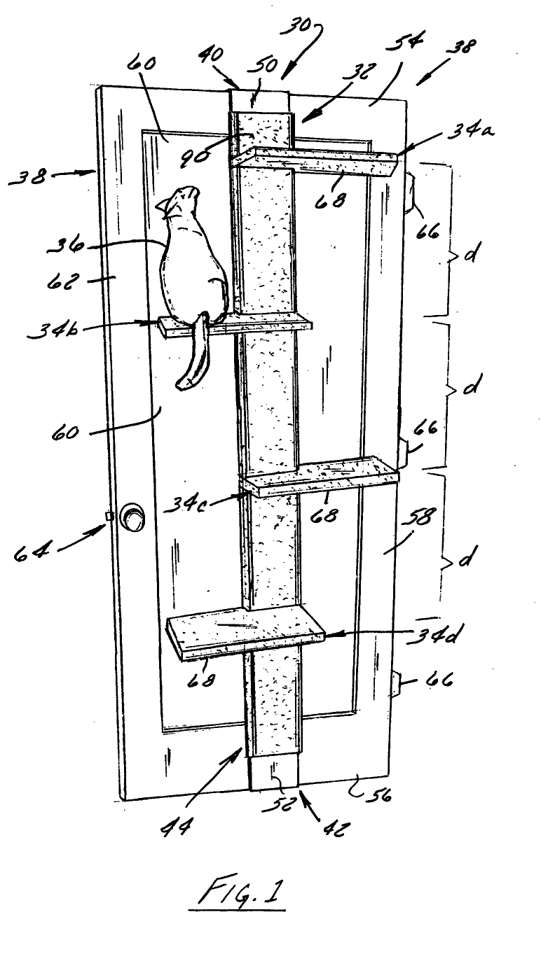

FIGS. 1-14 illustrate a preferred embodiment of a vertically extending cat climbing structure, i.e. cat climber 30, that has an elongate vertically extending spine 32 that carries a plurality of spaced apart and outwardly extending shelves or platforms 34a-34d upon which a cat 36, such as a domestic cat, a house cat, or the like (e.g., Felis catus or Felis silvestris catus), can perch or rest. Cat climber 30 mounts to a vertically extending structure, door 38, using at least one mounting bracket arrangement 40, 42.

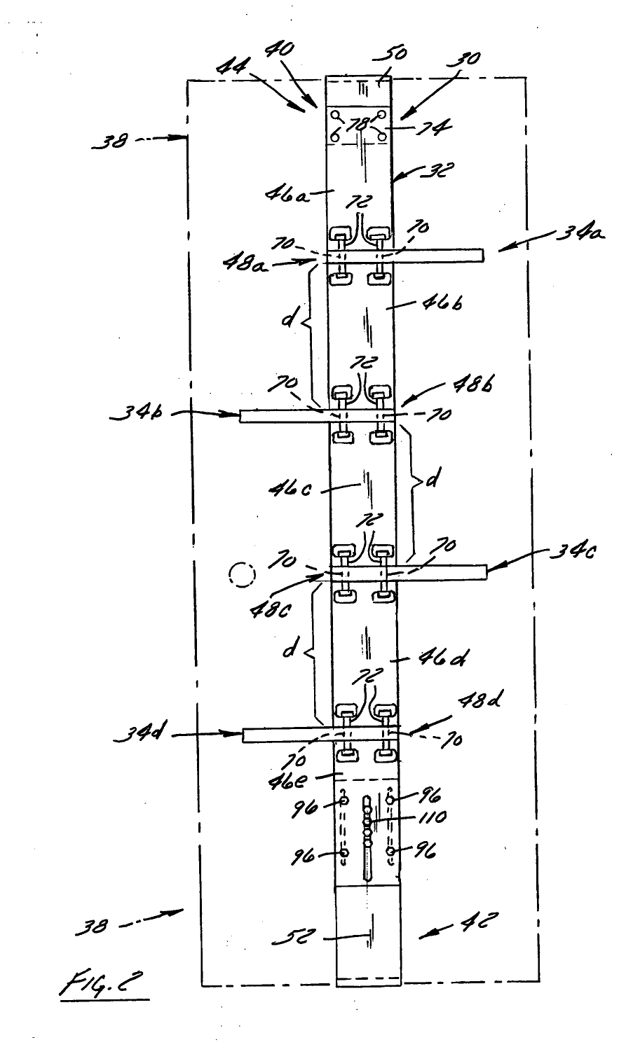

As is shown in more detail in FIGS. 2-3, the cat climber 30 is an assembly 44 that includes a plurality of pairs of spine panels 46a-46e, i.e., at least three panels, interconnected to platforms 34a-34d at joints 48a-48d. Assembly 44 also includes an upper mounting hook 50 that is part of upper mounting bracket arrangement 40 and a lower mounting hook 52 that is part of lower mounting arrangement 42. Each hook 50, 52 is configured to engage part of door 38. Door 38 typically is a standard interior door having a height of about eighty inches, a width of between about thirty inches and about thirty two inches, and a thickness of as much as two inches. At least one of the mounting bracket arrangements 40, 42 is constructed and arranged to permit adjustment for mounting on the particular door 38 to which the cat climber 30 is being attached. Such an assembly 44 is advantageous as it enables all of the components of the climber 30 to be retained in a retail displayable box having dimensions of no greater than about eighteen and one-eighth inches long, no greater than about fifteen and one-eighth inches wide, and no greater than about seven and one-quarter inches high.

The door 38 shown in FIG. 1 has a top rail 54, a bottom rail 56, a vertically extending butte stile 58, an interior panel 60, a vertically extending latch or lock stile 62, a door knob or handle 64 and hinges 66 used to attach it to a side rail of a door frame (not shown). If desired, the door 38 can be of a different configuration from that shown. It is an advantage of the present cat climber invention that it is designed to fit on interior and exterior doors of different types and sizes.

A cat climber 30 constructed in accordance with the present invention has at least a plurality of staggered and vertically spaced apart platforms 34a-34d that extend outwardly from the spine 32 which are spaced apart from one another by a distance, d, (FIG. 2) that is selected to enabling a cat 36 climbing the climber 30 to easily climb from one platform to another. While four spaced apart platforms 34a-34d are shown in the drawing figures, a greater or lesser number of platforms can be used. While each platform 34a-34d can cantilever outwardly from the spine 32, each platform 34a-34d cantilevers outwardly from between adjacent panels that form the spine 32 in the preferred embodiment shown in the drawing figures. While the platforms 34a-34d are shown parallel and staggered, one or more platforms can be inclined at an angle relative to horizontal. Where the platforms 34a-34d are staggered, there is overlap between adjacent platforms 34a-34b, 34b-34c, 34c-34d of between about one-fifth and about one-half of the platform length along a horizontal direction.

In one embodiment, the bottom platform 34d is spaced no more than about twenty-eight inches above the floor and each pair of adjacent platforms 34a-34d is spaced apart by a distance, d, that is between twelve and eighteen inches in order to allow even a cat that has been de-clawed to move from platform to platform. In a preferred embodiment, the bottom platform 34d is spaced between about seventeen and about twenty-two inches above the floor depending upon the length or height of the door 38 to which the climber 30 is mounted. In a currently preferred embodiment, the distance, d, between adjacent platforms 34a-34d is between about fifteen and about sixteen inches. In a currently preferred embodiment, the distance, d, is about fifteen and one-quarter inches. Such spacing also enables a cat 38 resting on one platform, such as platform 34c, to place its paws on an adjacent overlying platform 34b and scratch its head, such as one of its cheeks, on part of the adjacent overlying platform. As previously indicated, it also permits easy movement from one panel to the other when the cat 38 is moving up or down between platforms.

Each platform 34a-34d shown in the drawing figures is generally rectangular having a width and length great enough so as to receive and support a full-size adult house cat 36 perched thereon. In a preferred embodiment, at least one platform, typically at least the top platform 34a, is large enough for an adult house cat to lay down upon. In one embodiment, each platform has a width of no greater than about twenty inches and a length no greater than about twenty five inches. In a preferred embodiment, each platform 34a-34d extends outwardly from the spine 32 between about seven inches and about eight and a half inches and has a length of about seventeen inches. If desired, one or more of the platforms 34a-34d can be constructed to have a shape or configuration that differs from rectangular and can be oriented at an angle from the spine 32 instead of perpendicular as shown.

In the preferred climber embodiment shown in the drawing figures, each platform 34a-34d is a board or panel 67 (FIG. 12) made of wood, e.g. particle board, oriented strand board, plywood, etc., that is covered by an outer covering 68 that can be carpeting, sisal, rope, burlap, felt, a fabric, or another suitable material including a material that is engageable by the claws of cat 36. If desired, each platform 34a-34d can be made of a material other than wood or covered with another material.

As is best shown in FIGS. 2, 3, and 11, each platform 34a-34d has a pair of through-bores 70 (in phantom) through which extends at least one coupler 72 of one of the joints 48a-48d. Where the spine 32 is made of one piece, at least a plurality of spaced apart lag screws (not shown) can be used with each lag screw extending through the back of the spine 32 and into a rear edge of each platform 34a-34d to attach the platform to the spine 32 in a manner where it cantilevers outwardly therefrom.

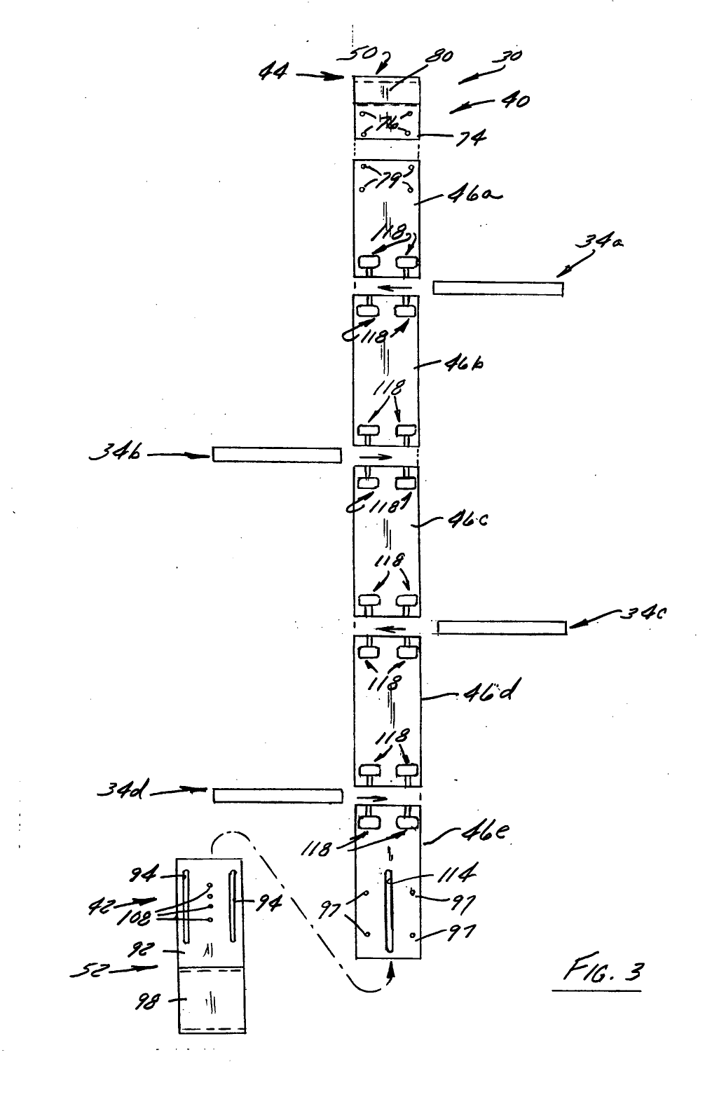

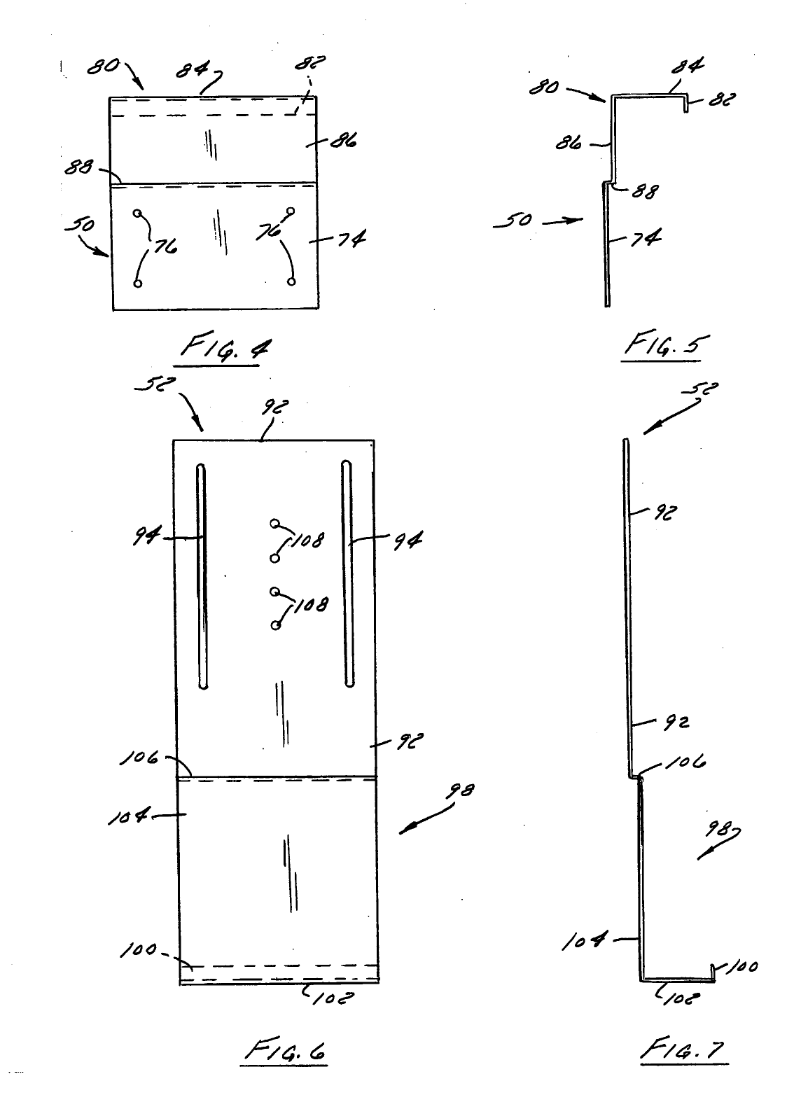

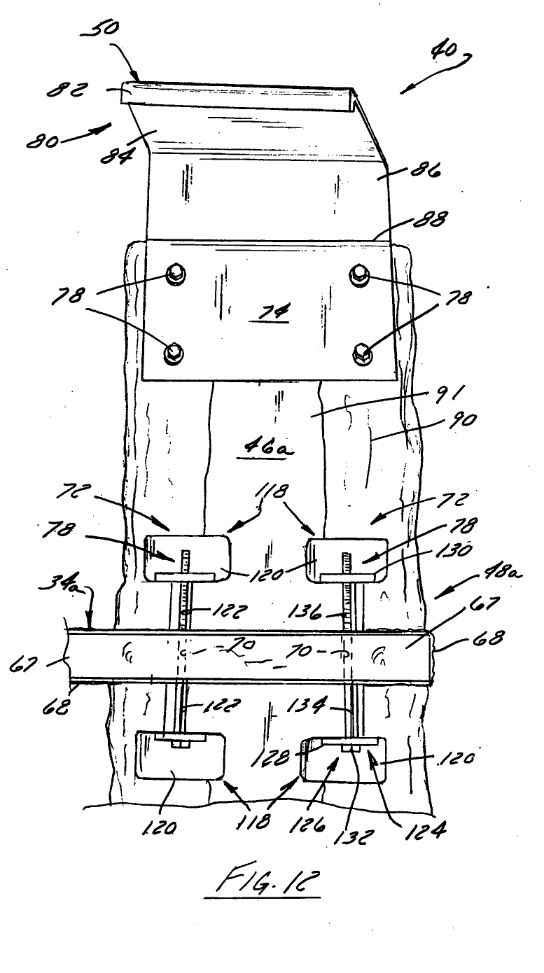

FIGS. 4 and 5 illustrate the upper hook 50 of the top mounting bracket arrangement 40 in more detail. The upper hook 50 overlies and releasably engages part of the top of the door 38 enabling the cat climber 30 to be hung on the door 38 in the manner shown in FIG. 1. With additional reference to FIG. 12, hook 50 includes a generally planar spine mounting bracket section 74 that has a plurality of pairs of bores 76 therethrough that each accept a fastener 78 (FIG. 12), such as a wood screw, used to attach the hook 50 to uppermost spine panel 46a. Each fastener 78 can have its free end received in a corresponding pilot bore or the like formed in spine panel 46a, such as the pilot bores 79 shown in FIG. 10.

Upper hook 50 also includes a door-engaging channel 80 that has an elongate, downturned lip 82 spaced apart by an angled or bent section 84 from a generally planar door framing section 86 that can be connected to the mounting bracket section 74 by an offset 88. When the climber 30 is mounted on door 38, the angled section 84 overlies and abuts against a top edge of the top rail 54 of the door 38 with the lip 82 located on one side of door 38 adjacent to or against door 38 and framing section 86 located on the other side of door 38 adjacent to or against door 38. In other words, the lip 82, angled section 84 and framing section 86 form a channel in which the top of the door 38 is securely received. As is best shown in FIG. 12, offset 88 spaces the mounting bracket section 74 from the door 38, which can help accommodate a layer of material 90, such as carpeting, sisal, rope, burlap, felt, a fabric, or the like, covering the spine 32 that is located between section 74 and door 38. In the preferred embodiment shown in the drawing figures, upper hook 50 is formed of a sheet of material, such as metal, such that the mounting bracket section 74, lip 82, angled section 84, and framing section 86 define a hook 50 of one-piece and unitary construction.

FIGS. 6 and 7 illustrate the lower hook 52 of the bottom mounting bracket arrangement 42 in more detail. The lower hook 52 underlies and releasably engages part of the bottom of the door 38 enabling the cat climber 30 to engage the door 38 at or near the bottom of the door 38 in the manner depicted in FIG. 1. Providing a second door mounting location at or adjacent the bottom of door 38 advantageously more securely mounts the climber 30 to the door 38 preventing the climber 38 from moving relative to the door 38 away from the door 38 or even side to side as cat 36 moves up and down along platforms 34a-34d.

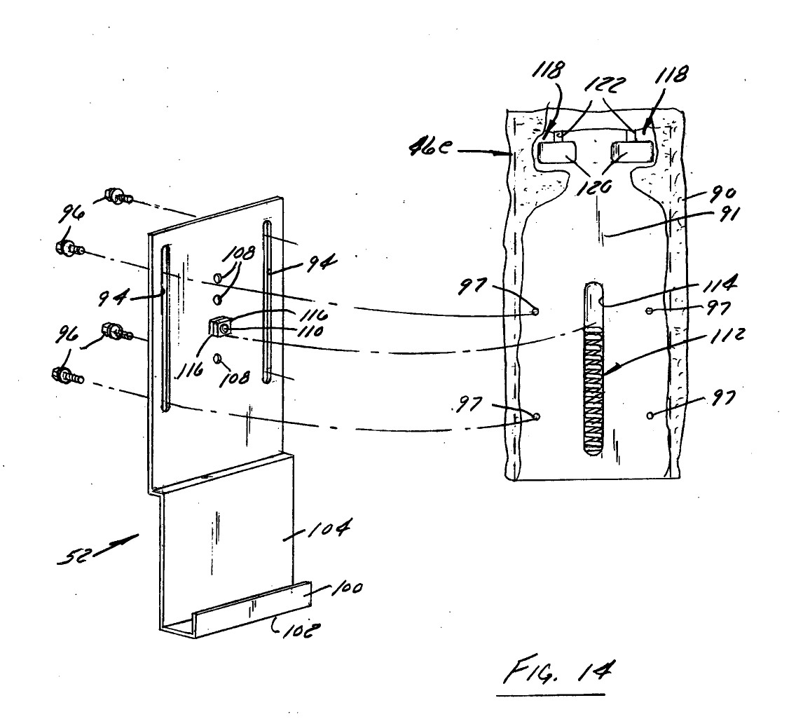

With additional reference to FIGS. 13 and 14, lower hook 52 includes a generally planar spine mounting bracket section 92 that has a pair of spaced apart and generally parallel slots 94 that each accepts a fastener 96 (FIGS. 13 and 14), such as a wood screw, used to attach the hook 52 to lowermost spine panel 46e in a manner that permits relative movement therebetween. Each fastener 96 can be guided into engagement with spine panel 46e by a corresponding pilot bore 97 formed in spine panel 46e, such as in the manner depicted in FIG. 14.

Hook 52 also includes a door-engaging channel 98 that has an elongate, upturned lip 100 spaced apart by an angled or bent section 102 from a generally planar door framing section 104 that can also be connected to the mounting bracket section 92 by an offset 106. Lip 100, angled section 102 and framing section 104 form a door receiving channel same as or similar to that formed by corresponding components of upper hook 50. In the preferred embodiment shown in the drawing figures, hook 52 is formed of a sheet of material, such as metal, such that the mounting bracket section 92, lip 100, angled section 102, and framing section 104 define a hook 52 of one-piece and unitary construction.

Lip 100 preferably has an upraised height that is small enough to fit underneath the bottom of door 38 in the gap between the door 38 and the floor during assembly of the cat climber 30 onto door 38. In a preferred embodiment, lip 100 has a height of no more than about three quarters of an inch. In a currently preferred embodiment, lip 100 has a height of about seven-sixteenth of an inch.

As is best shown in FIGS. 13 and 14, there is a plurality of spaced apart holes 108 located between slots 94 along a line that is generally parallel to slots 94. A fastener 110 extends through one of the holes 108 and engages a biasing element 112, such as a coil spring captured in compression, which is received in an elongate, longitudinally extending channel 114 formed in lowermost spine panel 46e. Selection of which hole 108 in which to place fastener 110 can depend upon the amount of biasing element force that is desired to be imparted to hook 52. Fastener 110 has a plurality of nuts 116 threaded onto it that define a stop that is received in channel 114 that abuts against biasing element 112.

When the lower hook 52 is assembled to the lowermost spine panel 46e in this manner, biasing element 112 urges the hook 52 towards its fully retracted position. When assembling the cat climber 30 onto door 38, upon application of manual force to the hook 52, the hook 52 can be pulled and moved relative to the lowermost spine panel 46e by as much as at least two inches enabling the overall length of the cat climber 30 to be increased as needed so it fits onto the door 38 to which it is being attached thereby advantageously enabling the climber 30 to accommodate significant variations in door length. When released, biasing element 112 urges the hook 52 back towards its fully retracted position thereby causing the cat climber 30 to be positively clamped onto door 38 between its two hooks 50, 52. Biasing element 112 causes a tension that urges the hooks 50, 52 together to be maintained thereby causing a clamping force on the door 38 to be maintained. As a result, once mounted on door 38, the climber 30 is positively retained on the door 38 such that inadvertent disengagement, particularly during abrupt cat movement, is prevented.

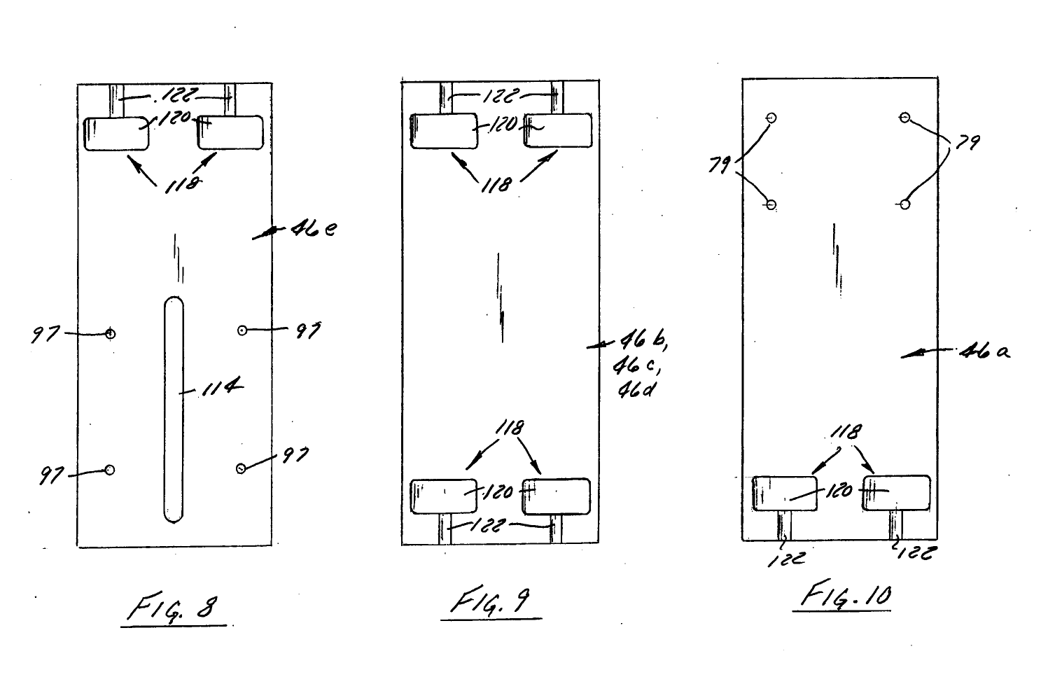

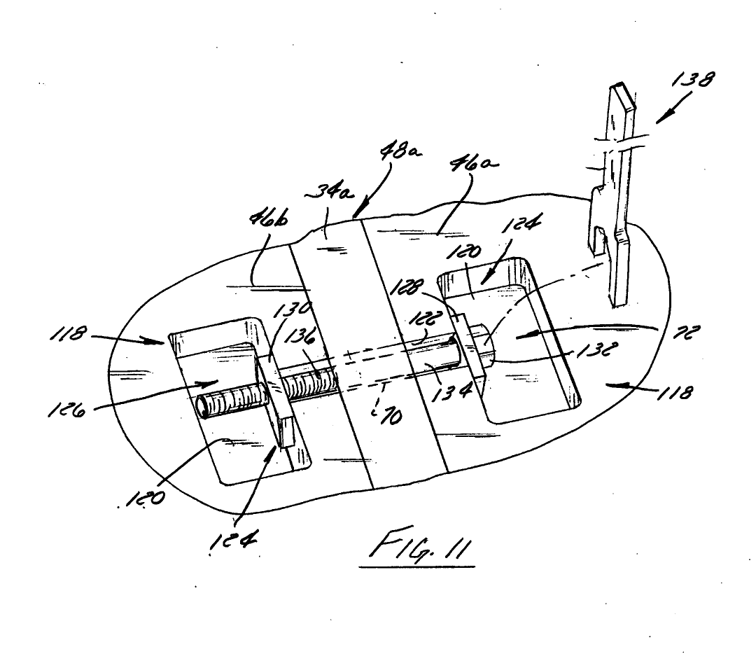

FIGS. 8-10 illustrate the rear of each spine panel 46a-46e that interconnects with platforms 34a-34d in forming cat climber assembly 44. As is best shown in FIGS. 2 and 3, the spine 32 is formed by a plurality of pairs of spine panels with there being an upper spine panel 46a (FIG. 10), a lower spine panel 46e (FIG. 8) and at least a plurality of intermediate spine panels 46b, 46c and 46d (FIG. 9). With exemplary reference to FIGS. 12-14, each spine panel 46a-46e is formed of a substantially rigid or self-supporting interior board or panel 91, such as a board made of wood, metal, plastic or the like, that is covered by an outer covering 90 that can be made of carpeting, sisal, rope, burlap, felt, a fabric, or another suitable material that can be engageable by claws of cat 36. If made of wood, it can be made of oriented strand board, particle board, or the like.

Each spine panel 46a-46e has at least a plurality of spaced apart coupling sockets 118 disposed along one edge that each includes a coupler access pocket 120 in communication with a coupler-seating channel 122. Intermediate spine panels 46b, 46c and 46d have a pair of coupling sockets 118 located along opposite edges, such as is shown in FIG. 9.

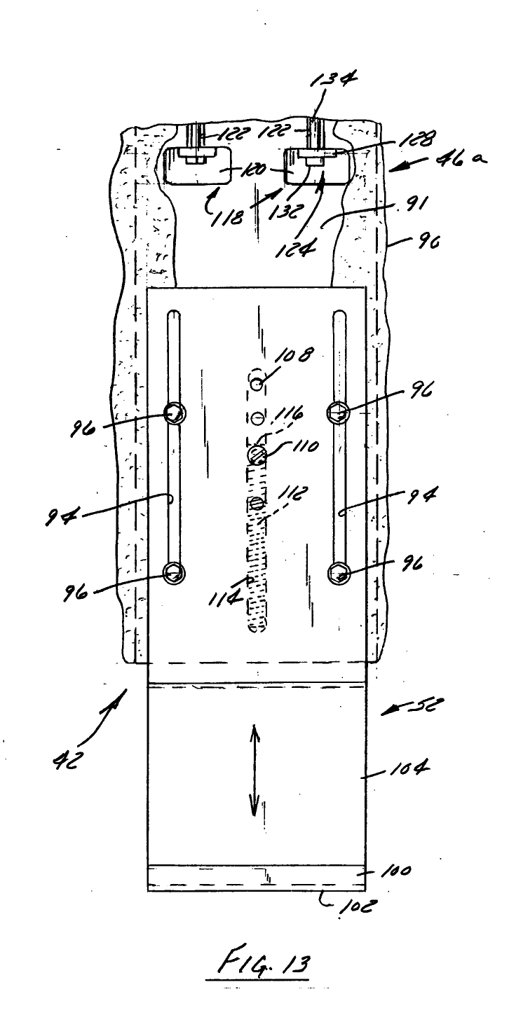

With additional reference to FIG. 11, each joint 48a-48d is formed via coupling assembly 124 that includes a coupler 72 that extends from the coupling socket 118 of one spine panel to the coupling socket 118 of an adjacent spine panel clamping one of the platforms therebetween when the coupler 72 is tightened. The coupler 72 includes a fastener 126 that cooperates with a pair of washers 128, 130 that engage the fastener 126 to enable a platform, such as platform 34a, to be securely clamped between a pair of spine panels, such as panels 46a and 46b, when tightened. The fastener 126 is a bolt that has a head 132 at one end, an unthreaded shank portion 134 and a threaded shank portion 136. One of the washers 128, shown abutting against fastener head 132 in FIG. 11, has a bore with an inner diameter that is larger than the outer diameter of the threaded shank portion 134 of fastener 126 so that it slides freely along the shank of the fastener 126 without engaging any fastener threads. The other one of the washers 130 is threaded so that it engages the threads of the threaded shank portion 134 of fastener 126.

In assembly, unthreaded washer 128 and fastener head 132 are placed in the coupler access pocket 120 of one coupling socket 118 of one spine panel 46a and the shank of fastener 126 placed in its corresponding coupler-seating channel 122. Platform 34a is manually maneuvered until the threaded shank portion 136 of fastener 126 is inserted through one of its through-bores 70 and the threaded shank portion 136 is seated in channel 122 of adjacent spine panel 34b. Thereafter, with threaded washer 130 received on the threaded shank portion 136 of fastener 126, a tool 138, such as an open face socket head wrench, is used to manually engage the head 132 of fastener 126 to turn the fastener 126 in a clockwise direction. As the fastener 126 is turned, rotation of its threaded shank 136 causes the threaded washer 130 to be urged against part of spine panel 46b ultimately clamping the adjacent panels 46a, 46b, together against platform 34a. In assembly, the fastener is repeatedly turned using wrench 138 until the clamping force between washers 130, 132 positively clamps platform 34a between spine panels 46a, 46b thereby also joining the panels 46a, 46b together end-to-end with one end of one panel 46a abutting against platform 34a and one end of the other panel 46b also abutting against platform 34a.

While only one side is shown in FIG. 11, typically, these steps are performed on the coupling assemblies 124 on both sides so that a secure joint 48a along the entire joint results. Such a completed joint 48a is more clearly shown in FIG. 12. These steps are repeated to produce each joint 48a-48d until the entire climber assembly 44 is put together.

When assembly is completed, the climber 30 is manually lifted and maneuvered until downturned lip 82 of upper hook 50 extends over and beyond the top edge of door 38 such that lip 82 is located on one side of door 38 and framing section 86 of hook 50 is located on the other side of door 38 hooking the climber onto door 38. To the extent needed, the spine 32 is then maneuvered until the bottom hook 52 is located adjacent the bottom edge of door 38. Thereafter, the bottom hook 52 is manually grasped and pulled downwardly to the extent necessary until its upturned lip 100 fits in the gap between the bottom edge of door 38 and the floor. The lip 100 is then urged through the gap until it is located on one side of the door 38 and the framing section 104 of the hook 52 is located on the other side of door 38 positively engaging door 38. Releasing bottom hook 52 causes the biasing element 112 to pull the hook 52 upwardly against door 38 positively engaging the hook 52 with door 38 securely clamping the climber 30 onto door 38 in the manner shown in FIG. 1.

The bottom hook 52 can advantageously easily be pulled downwardly to disengage it from the door 38, facilitating quick and easy removal. After bottom hook disengagement, the cat climber 30 is lifted to disengage the top hook 50 from the door 38.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A cat climber that is mountable on a door comprising:
(a) a plurality of vertically spaced apart and generally horizontal cat-supporting platforms; and
(b) a door mounting arrangement in operable cooperation with at least one of the platforms that engages the door in mounting the platforms to the door.

2. The cat climber of claim 1 wherein the platforms are horizontally staggered defining cat-traversable steps a cat can climb.

3. The cat climber of claim 2 further comprising a top platform that is large enough for a cat to perch or lay upon.

4. The cat climber of claim 3 further comprising a vertically extending spine interconnecting the platforms with each one of the platforms extending generally horizontally outwardly therefrom.

5. The cat climber of claim 4 wherein the spine has a generally planar surface that is disposed toward and adjacent the door to which the cat climber is mounted.

6. The cat climber of claim 4 wherein the spine comprises a plurality of pairs of vertically extending adjacent spine panels with each platform having a portion extending outwardly from between a pair of adjacent spine panels.

7. The cat climber of claim 6 further comprising at least one coupling assembly in engagement with each pair of the adjacent spine panels clamping a corresponding one of the platforms between each pair of adjacent spine panels.

8. The cat climber of claim 1 further comprising a plurality of pairs of adjacent and generally vertically extending spine panels that are disposed in engagement with each one of the platforms defining a joint therebetween that supports the each one of the platforms in an outwardly extending position upon which a cat can traverse.

9. The cat climber of claim 8 wherein each joint includes at least one coupling assembly that retains one of the platforms between a corresponding pair of adjacent spine panels.

10. The cat climber of claim 9 wherein the coupling assembly comprises a fastener disposed in engagement with each one of the pair of adjacent spine panels urging them together clamping the one of the platforms therebetween.

11. The cat climber of claim 9 wherein there is a plurality of the coupling assemblies that are spaced apart forming each joint interconnecting each pair of corresponding adjacent spine panels with a corresponding one of the platforms.

12. The cat climber of claim 1 wherein the door mounting arrangement comprises a mounting bracket that is movable relative to the door enabling mounting adjustment to the door.

13. The cat climber of claim 12 wherein the mounting bracket comprises a door-engaging hook and further comprising a biasing element in operable cooperation with the hook enabling movement of the hook relative to the door.

14. The cat climber of claim 13 further comprising a spine from which the plurality of platforms extends and wherein the biasing element is disposed in operable communication with the spine and in operable communication with the hook enabling the hook to move relative to the spine.

15. The cat climber of claim 14 wherein the biasing element is received in a channel in the spine and cooperates with a stop of the hook.

16. The cat climber of claim 14 further comprising a second door mounting arrangement that engages the door in mounting the cat climber to the door.

17. The cat climber of claim 16 wherein the second door mounting arrangement comprises a mounting bracket that is fixed to the spine.

18. The cat climber of claim 17 wherein the mounting bracket of the second door mounting arrangement comprises a hook.

19. The cat climber of claim 1 further comprising a plurality of pairs of generally vertically extending spine panels with each one of the platforms disposed between a pair of adjacent spine panels spacing the plurality of platforms apart, at least one fastener that engages each pair of adjacent spine panels connecting the adjacent spine panels and retaining the one of the platforms, and wherein the door mounting arrangement comprises an upper hook carried by one of the spine panels that hooks onto a top edge of a door and a lower hook carried by another one of the spine panels that hooks onto a bottom edge of the door.

20. The cat climber of claim 19 wherein one of the upper and lower hooks is movable relative to the spine panels enabling adjustment of the distance between the upper and lower hooks.

21. The cat climber of claim 19 wherein there is a plurality of fasteners extending between each pair of adjacent spine panels with each fastener having a head received in a first socket formed in one spine panel of the adjacent spine panel pair and having a nut threaded onto the fastener received in a second socket formed in the other spine panel of the adjacent panel pair wherein the fastener is tightened to clamp the platform between the adjacent pair of spine panels.

22. The cat climber of claim 21 wherein each platform extends generally outwardly and generally perpendicular to the adjacent pair of spine panels between which the platform is clamped.

23. The cat climber of claim 22 wherein a portion of each fastener is received in a channel formed in each one of the adjacent spine panels of the adjacent spine panel pair and is received in a bore that extends through the platform clamped between the adjacent spine panels.

24. A cat climber that is mountable on a door comprising:
(a) a generally vertically extending spine;
(b) a generally horizontal cat platform that extends outwardly from the spine;
(c) an upper door mounting bracket arrangement that engages the door adjacent or along a top edge of the door; and
(d) a lower door mounting bracket arrangement that engages the door adjacent or along a bottom edge of the door.

25. The cat climber of 24 wherein one of the door mounting bracket arrangement comprises a resiliently biased hook that is movable relative to the spine and the door clamping the door between the upper door mounting bracket arrangement and the lower door mounting bracket arrangement.

26. The cat climber of claim 25 further comprising a biasing element in operable communication with the spine and the hook enabling relative movement therebetween.

27. The cat climber of claim 26 further comprising a biasing element in operable communication with the spine and the hook enabling relative movement therebetween.

28. The cat climber of claim 24 wherein (a) the upper door mounting bracket arrangement comprises an upper hook having a lip defining a door-edge receiving channel that receives a top edge of the door when mounted thereto, (b) the lower door mounting bracket arrangement comprises a lower hook having a lip defining a door-edge receiving channel that receives a bottom edge of the door when mounted thereto, and (c) one of the upper hook and lower hook is resiliently biased toward the other one of the upper hook and lower hook positively clamping the door therebetween.

29. The cat climber of claim 28 further comprising a spring that is disposed in operable cooperation with the spine and the one of the upper hook and lower hook that resiliently biases the one of the upper hook and lower hook toward the other one of the upper hook and lower hook.

30. A cat climber that is mountable on a door comprising:
(a) a plurality of generally horizontally extending cat platforms that are horizontally staggered and spaced vertically apart;
(b) a plurality of pairs of generally vertically extending and adjacent spine panels; and
(c) a coupling assembly that engages each pair of adjacent spine panels clamping a corresponding one of the platforms between the adjacent spine panels.

31. A cat climber that is mountable on a door comprising:
(a) a plurality of generally horizontally extending cat platforms that are horizontally staggered and spaced vertically apart;
(b) a plurality of pairs of generally vertically extending and adjacent spine panels;
(c) a coupling assembly that engages each pair of adjacent spine panels clamping a corresponding one of the platforms between the adjacent spine panels
(d) an upper door mounting bracket arrangement that engages the door adjacent or along a top edge of the door;
(e) a lower door mounting bracket arrangement that engages the door adjacent or along a bottom edge of the door; and
(f) wherein one of the upper door mounting bracket and lower door mounting bracket is resiliently biased toward the other one of the upper door mounting bracket and lower door mounting bracket clamping the door therebetween when mounted thereto.

32. A method of mounting a cat climber to a door comprising:
(a) providing a cat climber having a spine that carries at least one outwardly extending platform, an upper door mounting bracket arrangement that engages the door adjacent or along a top edge of the door, a lower door mounting bracket arrangement that engages the door adjacent or along a bottom edge of the door, wherein one of the upper door mounting bracket and lower door mounting bracket is resiliently urged by a biasing element toward the other one of the upper door mounting bracket and lower door mounting bracket;
(b) maneuvering the cat climber relative to the door so that one of the upper door mounting bracket arrangement and lower door mounting bracket arrangement is disposed in engagement with one of the top edge and bottom edge of the door;
(c) displacing the resiliently biased door mounting bracket away from the other one of the upper door mounting bracket and the lower door mounting bracket;
(d) urging the displaced resiliently biased door mounting bracket into engagement with the other one of the top edge and bottom edge of the door; and
(e) releasing the displaced resiliently biased door mounting bracket causing the biasing element to displace the resilient biased door mounting bracket against the one of the top edge and bottom edge of the door.

33. The method of mounting a cat climber to a door wherein during step (e) the door is clamped between the upper door mounting bracket arrangement and lower door mounting bracket arrangement positively mounting the cat climber to the door.
